(19) United States
(12) Patent Application Publication
(10) Pub. No.: US 2002/0038269 A1
(43) Pub. Date: Mar. 28, 2002

(54) Accounting method

(76) Inventor: Kazuya Nishino, Toyama (JP)

Correspondence Address: STAAS & HALSEY LLP, 700 11TH STREET, NW, SUITE 500, WASHINGTON, DC, 20001, US

(21) Appl. No.: 09/779,497

(22) Filed: Feb. 9, 2001

(30) Foreign Application Priority Data
Sep. 25, 2000 (JP) 2000-290016

(51) Int. Cl. G06F 17/60

(52) U.S. Cl. 705/30

(57) ABSTRACT

An accounting method for collecting efficiently a charge for using an application program is provided. When an application program installed on a client was started and a predetermined function, such as printing, was performed, a function performance detecting program detects this, a user specifying information obtaining program obtains user specifying information for specifying a user of the client, and a user specifying information sending program sends it to a server via a network. On the server, a function performance detecting program detects that the predetermined function was performed on the client and a user specifying program specifies a user who used the function from the user specifying information. An application program type specifying program specifies the type of the application program used and an accounting program imposes charges on the user according to the type of the application program and the frequency of the use of the function.

### BACKGROUND OF THE INVENTION

(1) Field of the Invention

This invention relates to an accounting method and, more particularly, to an accounting method for imposing, by a server, a charge for using an application program installed on a client.

(2) Description of the Related Art

Conventionally, software for personal computers etc. has usually been provided to general consumers by what is called “package sale”.

In recent years, with the progress of communication technologies, such as Internet, a method in which services are provided by registering software with a server and in which a charge is imposed according to the length of time they were used is also spreading.

While “package sale” results in great “buying expenses” (“buying expenses” correspond to initial investment to a user), software bought may be seldom used, or be next to unusable because its performance or function is not so good as he/she expected. That is to say, buying expenses must be met without reviewing the performance, usability, and the like of software.

The latter method in which services are provided by software registered with a server does not produce the above problem of initial investment. However, a user must meet a charge corresponding to all working time from the beginning of use to the end of use. That is to say, a user must meet a charge corresponding to all inefficient operation time (including an operational error and time for referring to a help topic) before achieving his/her goal. It is impossible to fully satisfy a user of this.

### SUMMARY OF THE INVENTION

In order to address such problems, the present invention was made. In other words, an object of the present invention is to provide an accounting method that can impose a proper charge on a user according to the use of software.

In order to achieve the above object, an accounting method for imposing, by a server, a charge for using an application program installed on a client is provided. This accounting method comprises a function performance detecting step for detecting that a predetermined function of an application program installed on the client was performed, a user specifying step for specifying a user who performed the predetermined function, and an accounting step for imposing charges on a user specified by the user specifying step according to the frequency of performance detected by the function performance detecting step.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view for describing the operating principle of the present invention.

FIG. 2 is a view showing the configuration of an embodiment of the present invention.

FIG. 3 is a view showing in detail the configuration of the server shown in FIG. 2.

FIG. 4 is a view showing in detail the configuration of the clients shown in FIG. 2.

FIG. 5 is an example of a screen displayed when software is downloaded.

FIG. 6 is an example of a screen displayed when “Simplified Word Processor” downloaded on the screen shown in FIG. 5 is installed and executed.

FIG. 7 is an example of a screen for user registration displayed when a Print button on the screen shown in FIG. 6 is operated for the first time.

FIG. 8 is an example of a table showing information regarding users and the amount of charges imposed.

FIG. 9 is an example of electronic mail sent from a server after the completion of registration.

FIG. 10 is an example of a screen displayed when a user ID and password are registered.

FIG. 11 is an example of a screen displayed when an Amount of Charges Imposed button is operated.

FIG. 12 is a flow chart for describing an example of a process performed when a key function is performed on a client.

FIG. 13 is a flow chart for describing an example of a process performed on a server when it receives a request for user registration from a client.

FIG. 14 is a flow chart for describing an example of a process performed on a server when it receives a request to perform a key function from a client.

FIG. 15 is a flow chart for describing an example of a process performed on a client when the Amount of Charges Imposed button is operated.

FIG. 16 is a flow chart for describing an example of a process performed on a server when it receives a request to inform about the amount of charges imposed from a client.

### DESCRIPTION OF THE PREFERRED EMBODIMENTS

An embodiment of the present invention will now be described with reference to the drawings.

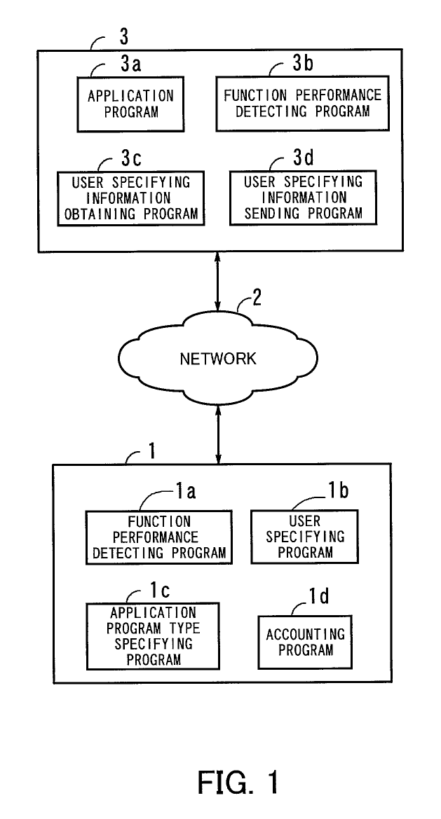

FIG. 1 is a view for describing the operating principle of the present invention. In FIG. 1, a server 1 used in an accounting method according to the present invention comprises a function performance detecting program 1a, a user specifying program 1b, an application program type specifying program 1c, and an accounting program 1d and is connected via a network 2 to a client 3 of a user.

The client 3 according to the present invention comprises an application program 3a, a function performance detecting program 3b, a user specifying information obtaining program 3c, and a user specifying information sending program 3d.

The function performance detecting program 1a on the server 1 detects that a predetermined function of the application program 3a installed on the client 3 was performed.

The user specifying program 1b specifies a user who performed a predetermined function of the application program 3a.

The application program type specifying program 1c specifies the type of the application program 3a used on the client 3 by a user.

The accounting program id imposes charges according to the type of the application program 3a specified by the application program type specifying program 1c and the number of times its function was performed.

The application program 3a on the client 3 is the one for which a charge is imposed. For example, it is downloaded from a server via a network and installed.

The function performance detecting program 3b detects that a predetermined function of the application program 3a was performed.

The user specifying information obtaining program 3c obtains information for specifying a user stored in a memory (not shown) when the function performance detecting program 3b detects that a predetermined function was performed.

The user specifying information sending program 3d sends the server 1 information for specifying a user obtained by the user specifying information obtaining program 3c.

The network 2 is, for example, Internet and transfers data between the server 1 and the client 3.

Now, operation in FIG. 1 will be described. In this example, the function of outputting data created by the application program 3a to a printer is set as a key function.

On the client 3, it is assumed that the application program 3a was started and that, for example, document and image data was created. Furthermore, it is assumed that a Print button was operated in order to output the data created to a printer (not shown). The function performance detecting program 3b informs the user specifying information obtaining program 3c that the key function was performed.

The user specifying information obtaining program 3c is informed that the key function was performed, obtains a user ID for specifying a user of the client 3 stored in the memory (not shown), and provides it to the user specifying information sending program 3d. In this case, the user specifying information obtaining program 3c also sends information for specifying the type of the application program 3a executed.

The user specifying information sending program 3d sends, via the network 2, the server 1 information for specifying a user provided from the user specifying information obtaining program 3c.

On the server 1, the function performance detecting program 1a receives the transmitted information for specifying a user, detects that the key function was performed on the client 3, and informs the user specifying program 1b of this. The user specifying program 1b specifies a user who performed the key function on the basis of the received information for specifying a user.

The application program type specifying program 1c specifies the type of the application program 3a by obtaining information for specifying the type of the application program 3a sent from the user specifying information sending program 3d and informs the accounting program 1d of it.

The accounting program id imposes charges on a user specified by the user specifying program 1b according to the number of times he/she used the key function and to the type of the application program 3a he/she used. In this example, the key function of the application program 3a was performed, so a charge of, for example, 100 yen will be imposed for using it once. If another application program was used, a charge will be imposed according to its type.

With the above processes, a charge will be imposed only when a key function of the application program 3a was performed. This prevents the charge for inefficient operation time before =achieving a user's goal from being imposed on him/her.

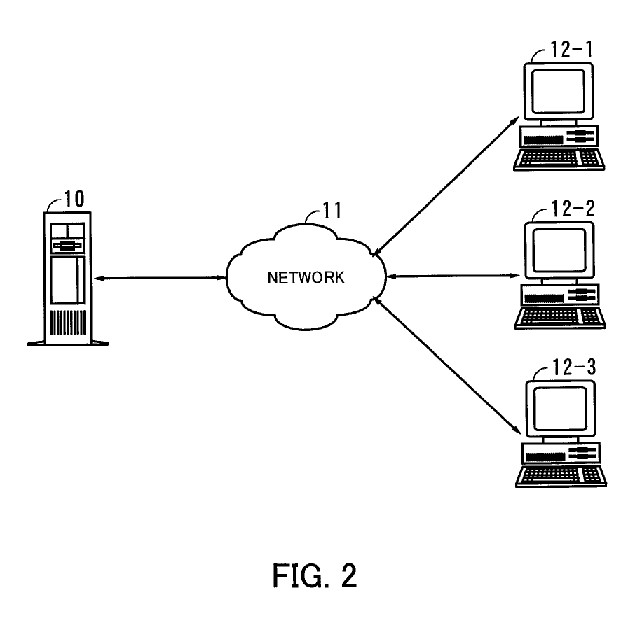

The configuration of an embodiment of the present invention will now be described with reference to FIG. 2. In FIG. 2, the server 10 performs a process for imposing a charge for using an application program on each of clients 12-1 through 12-3.

A network 11 consists of, for example, Internet and transfers data between the server 10 and the clients 12-1 through 12-3.

Application programs for which charges are imposed have been installed on the clients 12-1 through 12-3 and accounting information according to the number of times a user used them is sent to the server 10 via the network 11.

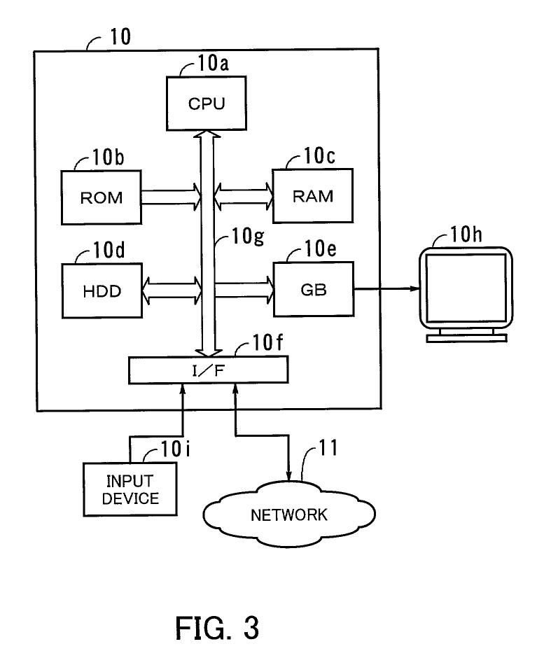

FIG. 3 is a view showing in detail the configuration of the server 10. As shown in FIG. 3, the server 10 comprises a central processing unit (CPU) 10a, a read only memory (ROM) 10b, a random access memory (RAM) 10c, a hard disk drive (HDD) 10d, a graphical board (GB) 10e, an interface (I/F) 10f, and a bus 10g. Furthermore, a display device 10h, an input device 10i, and the network 11 are externally connected to the server 10.

The CPU 10a performs various operation processes and controls each section of the apparatus, in compliance with programs stored in the HDD 10d.

The ROM 10b stores basic programs executed by the CPU 10a and data.

The RAM 10c temporarily stores programs to be executed =by the CPU 10a and data being operated by the CPU 10a.

The HDD 10d stores application programs executed by the CPU 10a and information for user authentication.

The GB 10e draws an image in accordance with a drawing command provided from the CPU 10a, converts image data created to image signals, and provides them to display device 10h.

The I/F 10f properly converts a data format when information is input from the input device 10i, and performs data format or protocol conversion when data is sent to and received from the network 11.

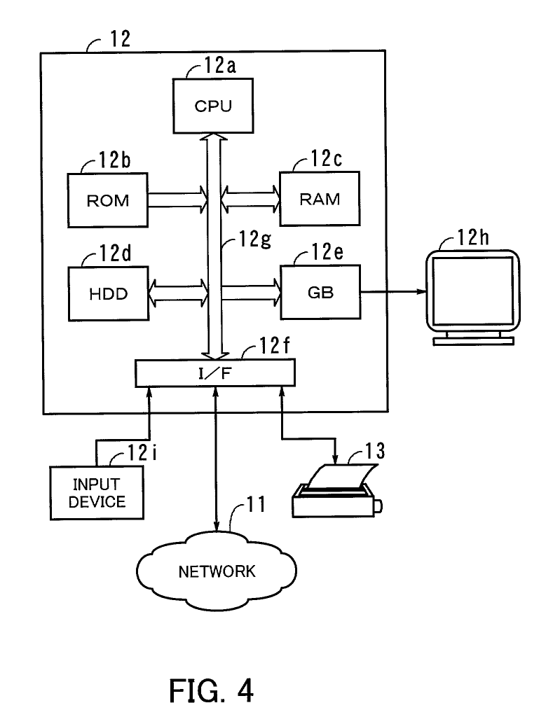

FIG. 4 is a view showing the configuration of the clients 12-1 through 12-3. As shown in FIG. 4, the client 12 comprises a CPU 12a, a ROM 12b, a RAM 12c, an HDD 12d, a GB 12e, an I/F 12f, and a bus 12g. Furthermore, a display device 12h, an input device 12i, the network 11, and a printer 13 are externally connected to the client 12. The function of each section is the same with FIG. 3, so a description of it will be omitted.

Now, operation in the above embodiment will be described with a case where an application program is installed on the client 12-1 and executed as an example. The description below will be given with the client 12-1 considered as the client 12.

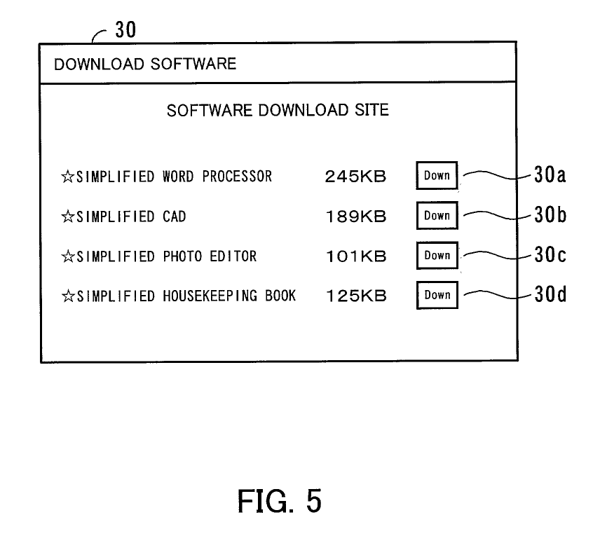

It is assumed that the client 12 (client 12-1) has accessed a software download site opened on the server 10. Then the CPU 10a in the server 10 reads out the appropriate HTML (hyper text markup language) document stored in the HDD 10d and sends it to the client 12 via the I/F 10f. The client 12 receives this HTML document via I/F 12f and provides it to the GB 10e. As a result, a screen shown in FIG. 5 will appear on the display device 12h of the client 12.

On this screen, a list of downloadable programs is displayed. Buttons 30a through 30d for beginning to download are displayed at the right of the programs respectively.

On this screen, it is assumed that the button 30a is pressed. Then a request to download the application program “Simplified Word Processor” being at the top of the list is sent to the server 10. As a result, the CPU 10a in the server 10 obtains the appropriate application program, being data (compressed), from the HDD 10d and sends it to the client 12.

On the client 12, this data is decompressed and installed. As a result, “Simplified Word Processor” can be used.

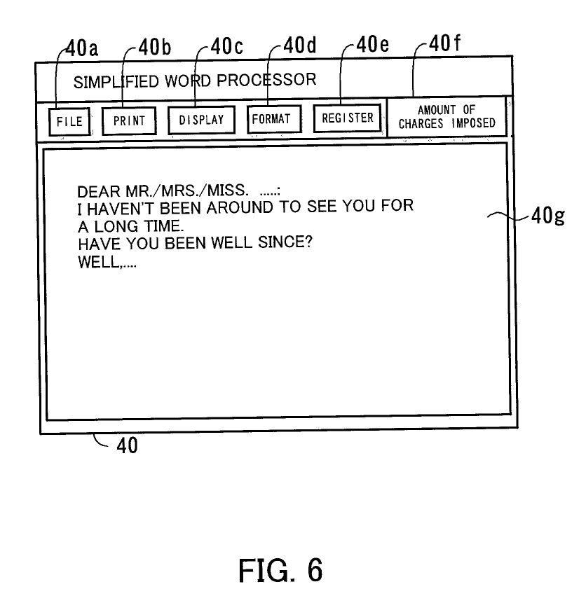

Decompressing and executing an application program will display a screen like the one shown in FIG. 6. In this example, an application program is a word processor, so a window 40 with a document creation area 40g for creating a document is displayed.

At the top of the document creation area 40g, a File button 40a operated to perform file manipulation, a Print button 40b operated to print a document created, a Display button 40c operated to edit contents displayed, a Format button 40d operated to change a format, a Register button 40e operated to register a user ID etc., and an Amount of Charges Imposed button 40f operated to refer to the amount of charges imposed to date are displayed.

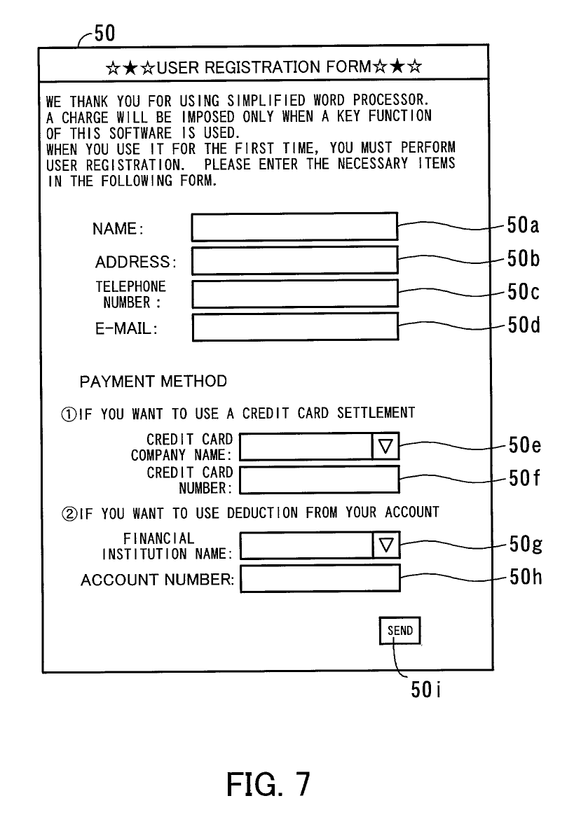

It is assumed that a document was created on this screen and that the Print button 40b was operated to print it out. The Print button 40b was operated for the first time, so a screen shown in FIG. 7 will appear on the display device 12h for user registration.

In this example, a message which indicates that a charge will be imposed only in the case of a key function of this software being used and which prompts a user to fill in necessary items because of user registration needed when he/she uses it for the first time is displayed. Under the message, text boxes 50a through 50d are displayed for entering his/her name, address, telephone number, and e-mail address respectively.

Under them, items for selecting a payment method are displayed. If he/she selects a credit card settlement, then he/she enters the name of a company which issued his/her credit card and its number in the text boxes 50e and 50f respectively.

If he/she selects deduction from his/her account, then he/she enters the name of a financial institution and the number of his/her account in the text boxes 50g and 50h respectively.

When a Send button 50i on this screen is pressed after filling in the necessary items, the contents entered will be obtained and sent from the client 12 to the server 10.

The server 10 performs a credit granting process by extracting information regarding payment from the information it received and by making inquiries at the appropriate credit card company or financial institution. If the credit granting process succeeds, then the server 10 judges that the credit card or account is valid and issues a user ID and password to him/her. Then the server 10 creates electronic mail accompanied with this information issued and sends it with the user's e-mail address obtained in advance as its destination.

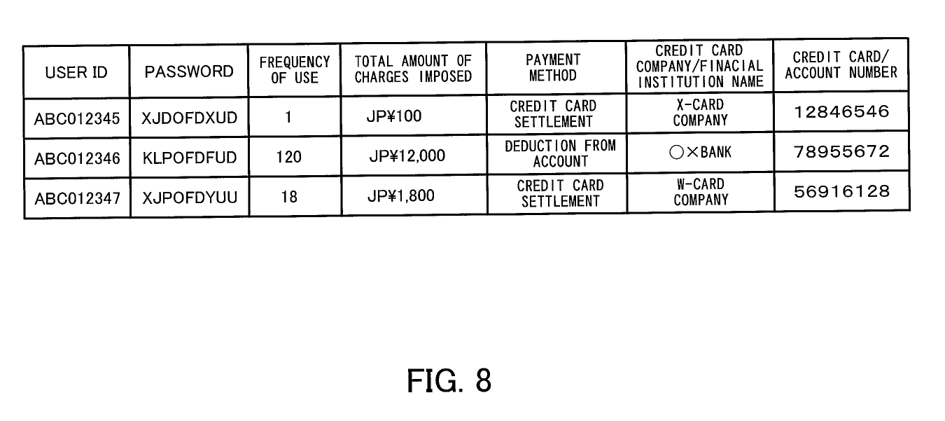

In this case, the server 10 ensures cells for the new user in a table, like the one shown in FIG. 8, which stores information regarding each user and the amount of charges imposed by associating them. In this example, cells for the new user are ensured in the first line of the table and the user ID, password, frequency of use, total amount of charges imposed, payment method, name of the credit card company/financial institution, and number of the credit card/account are stored in them. He/she used the key function for the first time, so the frequency of use is one. Furthermore, the charge for using it once is 100 yen, so the total amount of charges imposed is 100 yen.

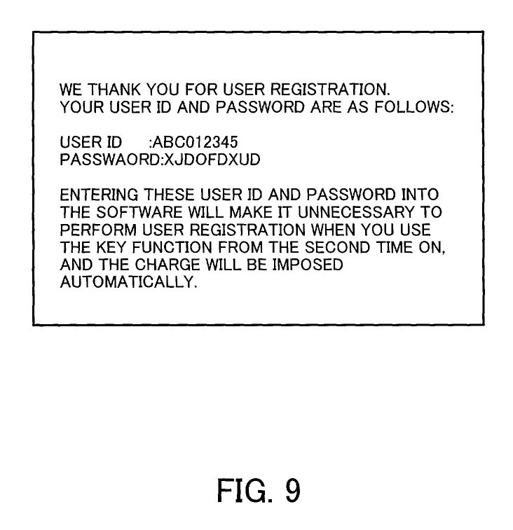

FIG. 9 is an example of electronic mail created. In this example, an acknowledgement for the user registration, a user ID and password, and a message that registering these user ID and password will make it unnecessary to perform user registration when the user uses a key function from the second time on are displayed.

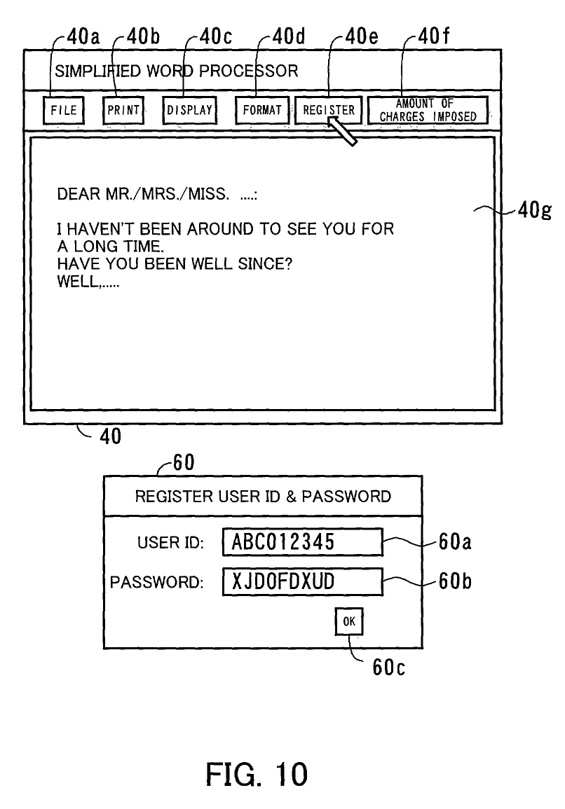

On a Register User ID & Password screen 60 displayed, as shown in FIG. 10, by operating the Register button 40e, the user who received such electronic mail enters the user ID and password given by the electronic mail in text boxes 60a and 60b respectively and operates an OK button 60c. As a result, this information is registered with the HDD 12d. When the registration is completed, a document created will be output from the printer 13.

Once a user ID and password are registered with the HDD 12d, a document created can be printed out afterward without entering this information. Procedures for using the key function from the second time on will now be described.

It is assumed that after the registration was completed, the Print button 40b was operated again. Then the CPU 12a in the client 12 obtains the registered user ID and password from the HDD 12d and sends, via the I/F 12f, the server 10 this information as a request to perform the key function.

The server 10 receives this information, refers to the table shown in FIG. 8, and judges whether the user ID and password are correct. If the server 10 judges that they are correct, then it sends information for permitting to perform the key function to the client 12 which made a request and increments values in the Frequency of Use and Total Amount of Charges Imposed cells of the table shown in FIG. 8. Values in these cells may be incremented after the server 10 receives from the client 12 notice that the performance of the key function is completed. This method prevents a charge from being imposed in the case of the key function not having been performed.

The client 12 which received the information for permitting to perform the key function outputs document data to be printed to the printer 13 and has the printer 13 print it.

The same procedures will be performed from the third time on. The user ID and password are sent to the server 10 each time the key function is performed. If user authentication succeeded, permission to perform the key function is given and accounting information on the server 10 is updated.

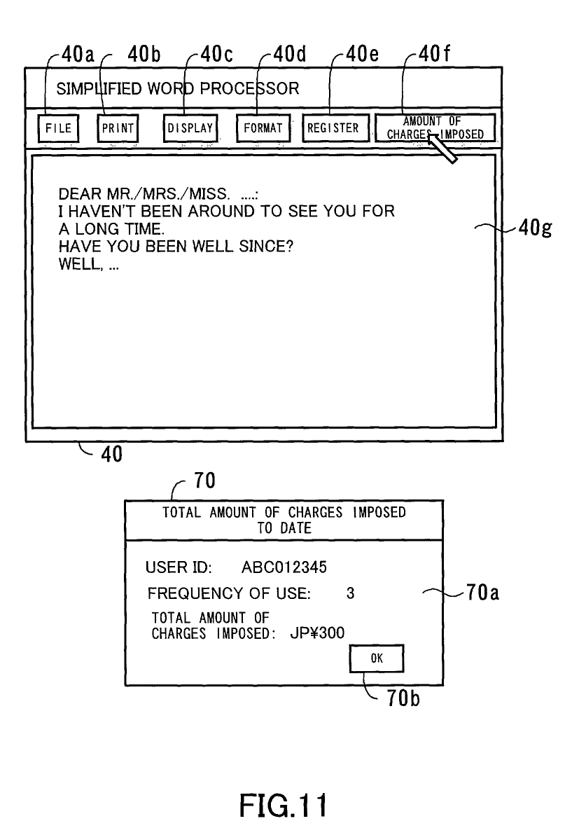

A user can refer to the amount of charges imposed by that time by pressing the Amount of Charges Imposed button 40f shown in FIG. 11. That is to say, when the Amount of Charges Imposed button 40f is pressed, the CPU 12a obtains the user ID and password from the HDD 12d and sends the server 10 them as a request to display the amount of charges imposed.

The server 10 first performs a user authentication process by referring to the user ID and password. If the user authentication succeeded, then it obtains the frequency of use and total amount of charges imposed from the table shown in FIG. 8 and sends them to the client 12 which made the request.

As a result, a window 70 shown in FIG. 11 appears on the client 12 and lets the user know the frequency of use and the total amount of charges imposed. In this example, a user ID, the frequency of use, and the total amount of charges imposed are displayed in a display area 70a. In addition, an OK button 70b operated to close the window 70 is displayed.

When a predetermined period elapsed after user registration or when a predetermined date and hour came, the server 10 refers to the table shown in FIG. 8 and informs each user by electronic mail about the amount of charges imposed on him/her. When a predetermined period elapsed after the notice by electronic mail, the server 10 collects the amount of charges imposed in compliance with a payment method specified at the time of contracting with each user. For example, the CPU 10a in the server 10 accesses a server (not shown) for a bank or credit card company, performs a credit granting process, and performs a process for deducting money from an account specified.

The above procedure enables a charge to be imposed only for the deed of printing work results. This enables to discern the availability of an application program at low cost and to exclude, for example, the disadvantage for a user of a heavy charge even in the case of work having dragged on because of unskillfulness etc.

Now, an example of a procedure performed in the above embodiment will be described.

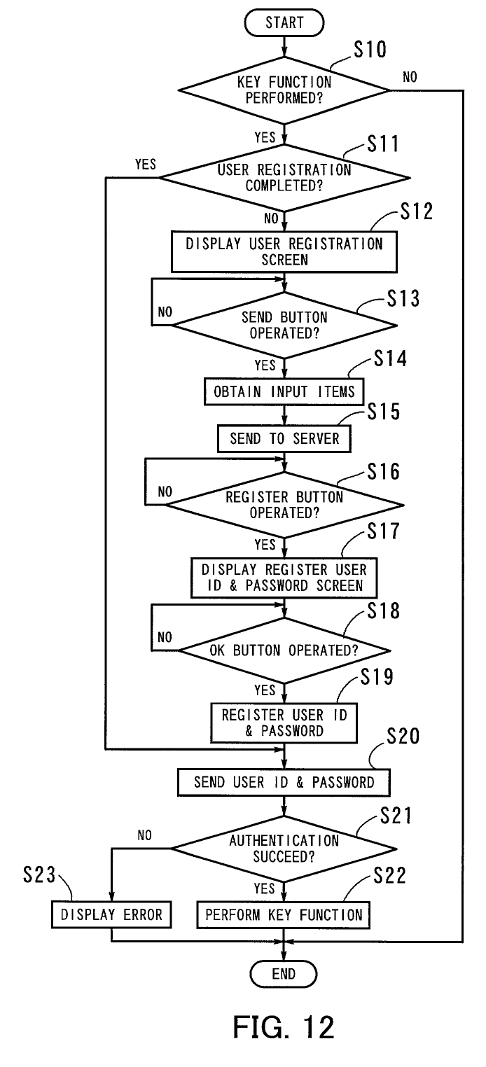

FIG. 12 is an example of a flow chart that will be started when a key function is performed on the client 12. The following procedure will be performed in compliance with this flow chart.

[S10] The CPU 12a judges whether or not the key function was performed. If the key function was performed, the CPU 12a proceeds to step S11. If the key function was not performed, the CPU 12a ends the procedure.

[S11] The CPU 12a judges whether or not user registration for an application program which is being executed is completed. If the user registration is completed, the CPU 12a proceeds to step S20. If the user registration is not completed, the CPU 12a proceeds to step S12. To be concrete, the user registration has not been performed at the time of the key function being used for the first time, so the CPU 12a will make the judgement “NO” and proceed to step S12.

[S12] The CPU 12a outputs the user registration screen shown in FIG. 7 to the display device 12h.

[S13] The CPU 12a judges whether or not the Send button 50i was operated. If the Send button 50i was operated, the CPU 12a proceeds to step S14. If the Send button 50i was not operated, the CPU 12a repeats the same process.

[S14] The CPU 12a obtains input items entered on the screen shown in FIG. 7.

[S15] The CPU 12a sends the server 10 the input items obtained in step S14.

[S16] The CPU 12a judges whether or not the Register button 40e was operated on the screen shown in FIG. 10. If the Register button 40e was operated, the CPU 12a proceeds to step S17. If the Register button 40e was not operated, the CPU 12a repeats the same process.

[S17] The CPU 12a causes the Register User ID & Password screen 60 shown in FIG. 10 to be displayed.

[S18] The CPU 12a judges whether or not the OK button 60c was operated after a user ID and password were entered. If the OK button 60c was operated, the CPU 12a proceeds to step S19. If the OK button 60c was not operated, the CPU 12a repeats the same process.

[S19] The CPU 12a registers the user ID and password entered on the Register User ID & Password screen 60 with the HDD 12d.

[S20] The CPU 12a sends the server 10 the user ID and password.

[S21] The CPU 12a judges whether or not user authentication performed on the basis of the user ID and password which it sent in step S20 succeeded. If the user authentication succeeded, the CPU 12a proceeds to step S22. If the user authentication did not succeed, the CPU 12a proceeds to step S23.

[S22] The CPU 12a performs the key function (printing out, for example).

[S23] The CPU 12a outputs an error screen indicating that the user authentication did not succeed to the display device 12h.

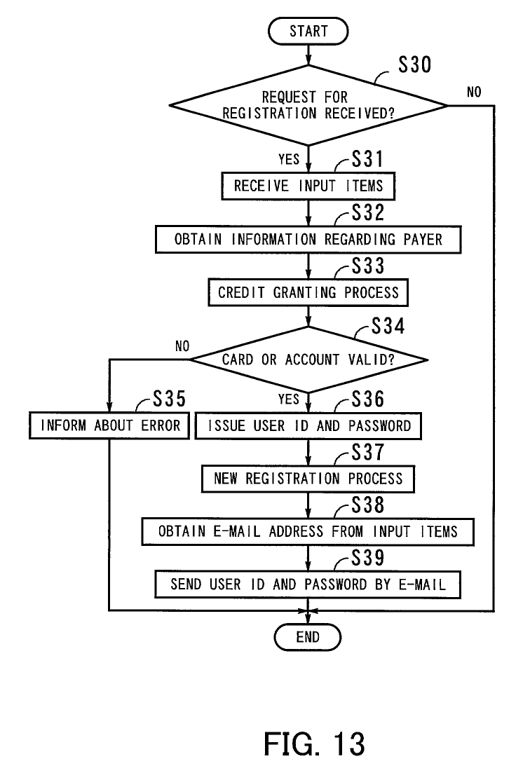

FIG. 13 is an example of a flowchart which will be started on the server 10 when it receives a request for user registration. The following procedure will be performed in compliance with this flow chart.

[S30] The CPU 10a judges whether or not a request for user registration was received. If it was received, the CPU 10a proceeds to step S31. If it was not received, the CPU 10a ends the procedure.

[S31] The CPU 10a receives the input items sent in step S15 of FIG. 12.

[S32] The CPU 10a obtains information regarding a payer from the input items. To be concrete, it obtains the name of the credit card company, the card number, etc. entered under “Payment Method” shown in FIG. 7.

[S33] The CPU 10a performs a credit granting process with the payer obtained in step S32 as a target. To be concrete, the CPU 10a makes an inquiry about the user at the credit card company or financial institution and judges whether or not he/she has been regularly registered.

[S34] The CPU 10a judge on the basis of the results of the credit granting process performed in step S33 whether or not the card or account is valid. If it is valid, the CPU 10a proceeds to step S36. If it is not valid, the CPU 10a proceeds to step S35.

[S35] The CPU 10a judges that the credit granting process failed, and sends an error screen to the client 12.

[S36] The CPU 10a issues a user ID and password.

[S37] The CPU 10a performs a new registration process, being a registration process for a new user. To be concrete, the CPU 10a adds new cells to the table shown in FIG. 8 and records the input items it received in step S31 in them. If a charge is also imposed for the first performance of a key function, the frequency of use and total amount of charges imposed are incremented by a defined value.

[S38] The CPU 10a obtains the user's e-mail address from the input items it received in step S31.

[S39] The CPU 10a sends e-mail to which the user ID and password are added to the e-mail address it obtained in step S38.

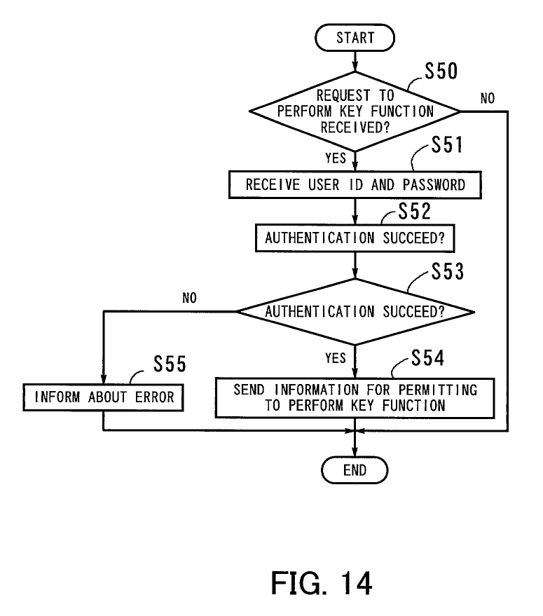

FIG. 14 is an example of a flow chart which will be started on the server 10 when it receives a request to perform a key function. The following procedure will be performed in compliance with this flow chart.

[S50] The CPU 10a judges whether or not a request to perform a key function was received. If it was received, the CPU 10a proceeds to step S51. If it was not received, the CPU 10a ends the procedure.

[S51] The CPU 10a receives a user ID and password sent from the client 12.

[S52] The CPU 10a performs an authentication process with the user ID and password it received.

[S53] The CPU 10a judges whether or not the authentication succeeded. If the authentication succeeded, the CPU 10a proceeds to step S54. If the authentication did not succeed, the CPU 10a proceeds to step S55.

[S54] The CPU 10a sends the client 12 information for permitting to perform the key function.

[S55] The CPU 10a sends the client 12 an error screen indicating that the authentication failed.

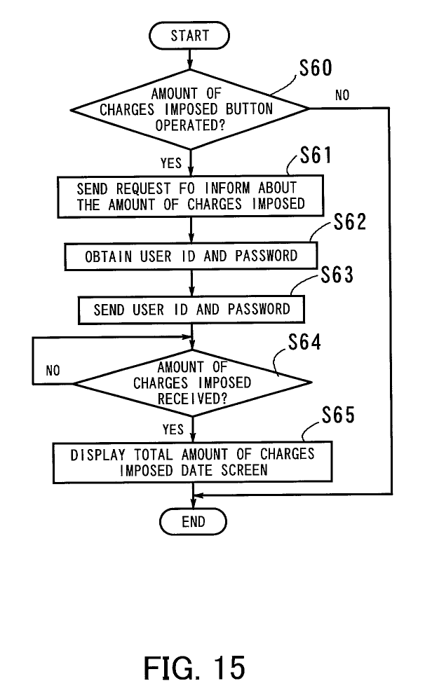

FIG. 15 is an example of a flow chart which will be started on the client 12 when the Amount of Charges Imposed button 40f is operated. The following procedure will be performed in compliance with this flow chart.

[S60] The CPU 12a judges whether or not the Amount of Charges Imposed button 40f was operated. If the Amount of Charges Imposed button 40f was operated, the CPU 12a proceeds to step S61. If the Amount of Charges Imposed button 40f was not operated, the CPU 12a ends the procedure.

[S61] The CPU 12a sends the server 10 a request to inform about the amount of charges imposed.

[S62] The CPU 12a obtains a user ID and password from the HDD 12d.

[S63] The CPU 12a sends the server 10 the user ID and password via the I/F 12f.

[S64] The CPU 12a judges whether or not it received information indicating the amount of charges imposed from the server 10. If the CPU 12a received it, the CPU 12a proceeds to step S65. If the CPU 12a did not receive it, the CPU 12a repeats the same process.

[S65] The CPU 12a displays the total amount of charges imposed to date, which it received in step S64, in the window 70 on the Total Amount of Charges Imposed to Date screen shown in FIG. 11.

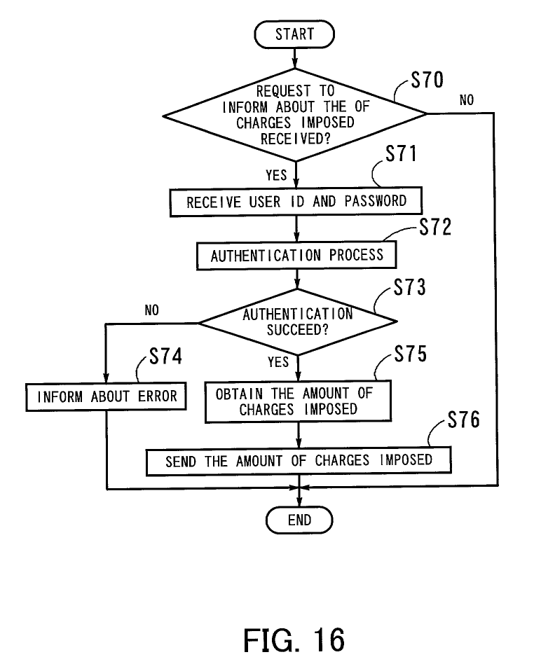

FIG. 16 is an example of a flow chart started on the server 10 when it receives a request to inform about the amount of charges imposed. The following procedure will be performed in compliance with this flow chart.

[S70] The CPU 10a judges whether or not it received the request to inform about the amount of charges imposed sent in step S61 shown in FIG. 15. If the CPU 10a received it, the CPU 10a proceeds to step S71. If the CPU 10a did not receive it, the CPU 10a ends the procedure.

[S71] The CPU 10a receives the user ID and password sent in step S63 shown in FIG. 15.

[S72] The CPU 10a refers to the table shown in FIG. 8 and performs an authentication process.

[S73] If the authentication succeeded, the CPU 10a proceeds to step S75. If the authentication did not succeed, the CPU 10a proceeds to step S74.

[S74] The CPU 10a sends the client 12 an error screen indicating that the authentication failed.

[S75] The CPU 10a obtains the appropriate amount of charges imposed from the table shown in FIG. 8.

[S76] The CPU 10a sends the amount of charges imposed which it obtained in step S75 to the client 12 which made the request.

The above flow charts enable to realize the functions of the embodiment of the present invention.

The above embodiment has been described on the assumption that the client 12 is always connected to the network 11. However, if the client 12 connects with the network 11 via a provider etc., for example, then data may be transmitted through a dial-up IP connection by closing a communication line between the client 12 and the provider at need.

Furthermore, in the above embodiment, an application program has been downloaded from the server 10. For example, however, an application program recorded on a CD-ROM may be installed directly on the client 12.

Moreover, the above embodiment has been described with printing out as an example of a key function, but the present invention is not limited to such a case. For example, outputting data created to a file or sending data created to other devices as electronic mail etc. may be set as a key function and a charge may be imposed for it.

Finally the above functions can be realized with a computer. In that case, the contents of functions which a server and client must have are described in a program recorded on a record medium which can be read with a computer. The above procedure is achieved with a computer by executing this program on the computer. A record medium which can be read with a computer can be a magnetic recording medium, a semiconductor memory, or the like. In order to place this program on the market, it can be stored on a portable record medium, such as a compact disk read only memory (CD-ROM) or a floppy disk. Alternatively, it can be stored in a memory of a computer connected via a network and be transferred to another computer via a network. When this program is executed on a computer, it is stored on a hard disk etc. in the computer and is loaded into a main memory.

As described above, an accounting method for imposing, by a server, a charge for using an application program installed on a client according to the present invention comprises a function performance detecting step for detecting that a predetermined function of an application program installed on the client was performed, a user specifying step for specifying a user who performed the predetermined function, and an accounting step for imposing charges on a user specified by the user specifying step according to the frequency of performance detected by the function performance detecting step. This enables to add a charge only when a predetermined function, being a key, was performed.

Moreover, an accounting method for imposing, by a server, a charge for using an application program installed on a client comprises a function performance detecting step for detecting that a predetermined function of an application program installed on the client was performed, a user specifying information obtaining step for obtaining information for specifying a user in the case of the performance of the predetermined function having been detected by the function performance detecting step, and a user specifying information sending step for sending the server the information for specifying a user obtained by the user specifying information obtaining step. This enables a user to pay a charge for using an application program after judging, for example, whether it answers his/her intended purpose.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An accounting method for imposing, by a server, a charge for using an application program installed on a client, the method comprising:
a function performance detecting step for detecting that a predetermined function of an application program installed on the client was performed;
a user specifying step for specifying a user who performed the predetermined function; and
an accounting step for imposing charges on a user specified by the user specifying step according to the frequency of performance detected by the function performance detecting step.

2. The accounting method according to claim 1, wherein the predetermined function is to output data from the client to an external device.

3. The accounting method according to claim 1, further comprising an application program type specifying step for specifying the type of the application program, wherein the accounting step imposes a charge according to the type of the application program specified by the application program type specifying step.

4. The accounting method according to claim 1, further comprising a user registration step for performing user registration in the case of the predetermined function having been performed for the first time.

5. The accounting method according to claim 1, further comprising an imposed charge amount informing step for informing a client which made a request about the amount of charges imposed at that time.

6. A server for imposing a charge for using an application program installed on a client, the server comprising:
function performance detecting means for detecting that a predetermined function of a program installed on the client was performed;
user specifying means for specifying a user who performed the predetermined function; and
accounting means for imposing charges on a user specified by the user specifying means according to the frequency of performance detected by the function performance detecting means.

7. The accounting method according to claim 1, further comprising a charge deducting step for deducting automatically charges imposed by the accounting step from an account being under the user's name.

8. An accounting method for imposing, by a server, a charge for using an application program installed on a client, the method comprising:
a function performance detecting step for detecting that a predetermined function of an application program installed on the client was performed;
a user specifying information obtaining step for obtaining information for specifying a user in the case of the performance of the predetermined function having been detected by the function performance detecting step; and
a user specifying information sending step for sending the server the information for specifying a user obtained by the user specifying information obtaining step.

9. A client for having a server impose a charge for using an application program installed on a client, the client comprising:
function performance detecting means for detecting that a predetermined function of a program installed on the client was performed;
user specifying information obtaining means for obtaining information for specifying a user in the case of the performance of the predetermined function having been detected by the function performance detecting means; and
user specifying information sending means for sending the server the information for specifying a user obtained by the user specifying information obtaining means.
